(19) United States
(12) Patent Application Publication
(10) Pub. No.: US 2006/0095966 A1
(43) Pub. Date: May 4, 2006

(54) Method of detecting, comparing, blocking, and eliminating spam emails

(76) Inventor: Shawn Park, Canoga Park, CA (US)

Correspondence Address: ROZSA LAW GROUP LC, 15910 VENTURA BOULEVARD, SUITE 1601, ENCINO, CA, 91436-2815, US

(21) Appl. No.: 10/981,436

(22) Filed: Nov. 3, 2004

(51) Int. Cl. G06F 12/14; H04L 9/32; G06F 11/00; G06F 11/30; G06F 11/22; G06F 11/32; G06F 11/34; G06F 11/36; G06F 12/16; G06F 15/18; G08B 23/00

(52) U.S. Cl. 726/22; 713/188; 726/24

(57) ABSTRACT

A method of detecting, comparing, blocking, and eliminating spam emails sent through email servers of Internet service providers (ISPs) or to email users' email-boxes. The method includes the steps of generating a spam decipher signature for each email in an ISP's mail server or a user's email-box, comparing newly generated spam decipher signatures to a server or user database containing spam decipher signatures of known spam emails to detect spam emails when there is a probability match at a pre-determined high percentage, and preventing the spam emails from going through the ISP's mail server or to the email user as non-spam emails. The method also includes the steps of updating a master spam decipher signature database by comparing spam decipher signatures in a new signature database with existing spam decipher signatures in the master database, incrementing a counter value of a matching spam decipher signature by the number of matches, and adding all new spam decipher signatures that have counter values reaching or exceeding a pre-set threshold and therefore are considered spam to the master spam decipher signature database. The method further includes the steps of initially loading the master spam decipher signature database to the ISP email server or the user's computer to establish the server or user database, and updating the server or user database with the master spam decipher signature database.

### BACKGROUND OF THE INVENTION

1. Field of the Invention

The present invention relates generally to the field of telecommunication technologies, and more particularly, the present invention relates to the field of a method of detecting, comparing, blocking and eliminating spam emails.

2. Description of the Prior Art

Emails are widely used now in modern communications with the advancement of computer network technologies. However, as email usage becomes ever more popular among the general public, email spam too become an ever grown problem. Spam emails are also known as “junk emails” which are unsolicited emails, often of a commercial nature, sent indiscriminately to multiple mailing lists, individuals, or newsgroups. As a result, how to prevent and detect email spam is a very important task and challenge to not only emails users but also network service providers and administrators. The following patents and published patent applications are pertinent to this field of art:
1. U.S. Pat. No. 6,023,723 issued to McCormick on Feb. 8, 2000 for “Method And System For Filtering Unwanted Junk E-Mail Utilizing A Plurality Of Filtering Mechanisms” (hereafter the “'723 McCormick Patent”);
2. U.S. Pat. No. 6,052,709 issued to Paul on Apr. 18, 2000 for “Apparatus And Method For Controlling Delivery Of Unsolicited Electronic Mail” (hereafter the “Paul patent”);
3. U.S. Pat. No. 6,266,692 B1 issued to Greenstein on Jul. 24, 2001 for “Method For Blocking All Unwanted E-Mail (SPAM) Using A Header-Based Password” (hereafter the “Greenstein patent”);
4. U.S. Pat. No. 6,330,590 B1 issued to Cotten on Dec. 11, 2001 for “Preventing Delivery Of Unwanted Bulk E-Mail” (hereafter the “Cotten patent”);
5. U.S. Pat. No. 6,393,464 B1 issued to Dieterman on May 21, 2002 for “Method For Controlling The Delivery Of Electronic Mail Messages” (hereafter the “Dieterman patent”);
6. U.S. Pat. No. 6,421,709 B1 issued to McCormick on Jul. 16, 2002 for “E-Mail Filter And Method Thereof” (hereafter the “'709 McCormick patent”);
7. U.S. Pat. No. 6,546,416 B1 issued to Kirsch on Apr. 8, 2003 for “Method And System For Selectively Blocking Delivery Of Bulk Electronic Mail” (hereafter the “Kirsch patent”);
8. U.S. Pat. No. 6,654,787 B1 issued to Aronson on Nov. 25, 2003 for “Method And Apparatus For Filtering E-Mail” (hereafter the “Aronson patent”);
9. U.S. Pat. No. 6,732,149 B1 issued to Kephart on May 4, 2004 for “System And Method For Hindering Undesired Transmission Or Receipt Of Electronic Messages” (hereafter the “Kephart patent”);
10. U.S. Pat. No. 6,732,157 B1 issued to Gordon on May 4, 2004 for “Comprehensive Anti-Spam System, Method, And Computer Program Product For Filtering Unwanted E-Mail Messages” (hereafter the “Gordon patent”);
11. United States Patent Application Publication No. US 2003/0225841 A1 published on Dec. 4, 2003 for “System And Method For Preventing Spam Mails” (hereafter the “Song Publication”);
12. United States Patent Application Publication No. US 2004/0083270 A1 published on Apr. 29, 2004 for “Method And System For Identifying Junk E-Mail” (hereafter the “Heckerman Publication”); and
13. United States Patent Application Publication No. US 2004/0093384 A1 published on May 13, 2004 for “Method Of And System For, Processing Email In Particular To Detect Unsolicited Bulk Email” (hereafter the “Shipp Publication”).

The above cited prior art references disclose various approaches in dealing with the problem of email spam. Many of the methods and apparatus disclosed in these prior art references involve the using of filters or stripping the emails to block or detect spam emails.

For example, the '703 McCormick patent discloses a system and method for filtering junk emails. The user is provided with or compiles a list of email addresses or character strings which the user would not wish to receive to product a first filter. A second filter is provided including names and character strings which the user wishes to receive. Any email addresses or strings contained in the first filter will be automatically eliminated from the user's system. Any email addresses or strings contained in the second filter would be automatically sent to the user's “in box”. Any email not provided in either of the filter lists will be sent to a “waiting room” for user review. If this user review results in the user rejecting any email, the address as well as specific character strings included in this email would be transmitted to a central location to be included in a master list.

The Paul patent also deals with the subject of discarding unwanted emails. Upon receipt of an incoming mail address to the spam probe addresses, the spam control center automatically analyzes the received spam email to identify the source of the message, extracts the spam source data from the message, and generates an alert signal containing the spam source data. This alert signal is broadcast to all network servers and/or all user terminals within the network. A filtering system implemented at the servers and/or user terminals receives the alert signal, updates stored filtering data using the spam source data retried from the alert signal, and controls delivery of subsequently received email messages received from the identified spam source.

The Greenstein patent discloses a method for blocking unwanted emails. The method includes an additional capability for the senders of the emails to request a pass-code associated with a specific email address in a lookup directory, before sending an email to that address.

The Cotten patent also discloses a system for preventing delivery of unwanted bulk email. The basic on-line email message, after elimination of source and addressee identification (which elimination process is often referred to as “stripping” the email), is scanned and coded to provide a signature identification (ID) code. A set of typically three identical messages going to different email addresses is detected to signify spam in the email flow stream. Then the spam signature ID code is stored for use in eliminating future such messages at either a central server or one at an individual recipient's site. The signature code is typically calculated numerically, i.e., as the well known checksum in a 16-bit cyclic redundancy check (CRC) routine. The spam identification process requires that the CRC hash codes of differently addressed emails to be identical for signifying that the emails are spam. The system includes a central server which detects the spam and block it out with a comparative system to compare the quantity of emails to known spam emails.

The Dieterman patent for controlling the delivery of electronic emails has a method which comprises the steps of creating an allowed list of electronic addresses with which the user is permitted to freely exchange messages and also a method for allowing an administrator to selectively approve messages which are sent to or received from entities whose electronic addresses do not appear on the allowed list.

The '709 McCormick patent, as compared to the previously discussed '703 McCormick patent, adds an additional concept of a collaborative filter used for employing message base filtering that is not effected by e-mail header forgery and utilizes the networked intelligence of end users to maintain a highly inaccurate and comprehensive filter. The collaborative filter would then use the real-time input from the end users to keep the users involved in the filtering process.

The Kirsch patent discloses a method for blocking delivery of bulk emails. The system issues a challenge to the senders which must be met before the email can go through. The origin address of an email message is validated to enable blocking of email from spam email sources by preparing, in response to the receipt of a predetermined email message from an unverified source address, a data key encoding information reflective of the predetermined email message. This message, including the data key, is then issued to the unverified source address. The computer system then operates to detect whether a response email message, responsive to the challenge email message, is received and whether the response email message includes a response key encoding predetermined information reflective or a predetermined aspect of the challenge email message. The unverified source address may be recorded in a verified source address list. Thus, when an email message is received, the computer may operate to accept receipt of a predetermine email message on condition that the source address of the predetermined email message is recorded in the verified source address list and alternatively on condition that the predetermine email message includes the response key.

The Aronson patent also deals with a method and apparatus for filtering email.

The Kephart patent is a system for hindering undesired email transmissions.

The Gordon patent discloses a system and computer program product to filter unwanted email. After receiving electronic mail messages, the electronic mail messages that are unwanted are filtered utilizing a combination of techniques, including: compound filters, paragraph hashing, and Bayes rules. The electronic mail messages that are filtered as being unwanted are then categorized.

As an option, the paragraph hashing disclosed in the Gordon Patent may utilize a message-digest algorithm version 5 (MD5). MD5 is an algorithm that is used to verify data integrity through the creation of a 128-bit message digest from data input that is claimed to be as unique to that specific data as a fingerprint is a specific individual.

To facilitate this process, content of the electronic mail messages may be normalized prior to utilizing the paragraph hashing. Such normalizing may include removing punctuation of the content, normalizing a font of the content, and/or normalizing a case of the content. As a further option, the paragraph hashing may exclude a first and last paragraph of content of the electronic mail messages, as spammers often alter such paragraphs to avoid filtering by paragraph hashing. The hashes of known unwanted electronic mail messages may each have a level associate therewith. Thus, the hashes having a higher level associated therewith may be applied to the electronic mail messages prior to the hashes having a lower level associated therewith.

The Song Publication discloses a system and method for preventing spam mails. A spam mail information collection server extracts base information for spam mail determination from header information of spam mails received at false mail addresses, databases the extracted spam mail determination base information and provides the databased spam mail determination base information to at least one mail server. The mail server receives the spam mail determination base information and stores it in a database. Upon receiving a new mail, the mail server analyzes header information of the received new mail, searches the spam mail determination base information database for the analyzed header information to determine whether the new mail is a spam mail, and blocks the reception of the new mail if the mail is determined to be a spam mail.

The Heckerman Publication discloses a method and system for identifying junk email. The information in the training store is then used to train the filter for future classifications, thus customizing the filter for the particular recipient.

The Shipp Publication discloses the concept of analyzing patterns in email traffic which indicate or suggest that the emails are spam. Analysis of email takes place by scanning a database of data abstracted from emails. These data are primarily abstracted from the emails when regarded as “containers”.

While various approaches of trying to address and block spam emails have been developed, email spam is still a significant problem to many users and it is still desirable to create and develop new methods and technologies for effectively and efficiently detecting, comparing, blocking, and eliminating spam emails.

### SUMMARY OF THE INVENTION

The present invention is directed to a new and unique method of detecting, comparing, blocking, and eliminating junk or spam emails.

Described generally, the basic scheme of the present invention spam detecting, comparing, blocking, and eliminating method is to create and maintain a database of known spam emails so that a client who obtains the subscription service of the present invention gets a current list of all of the known spam emails and the spam email is immediately deleted so the client never gets it.

One of the key features of the present invention is that there will be a database created of emails which the present invention program will be able to track through the present invention central server so that each email will be assigned what is called a Spam Decipher version 6 (SD6) spam number which is a variable computer hash number that is assigned to that specific email. When a user signs on with the present invention email spam detecting, comparing, block and eliminating service, the user will get an initial database that will be downloaded into the user's computer system so that all the emails that are known to be junk or spam emails as of that date and have SD6 hash numbers will automatically be picked up so that the user knows it is a junk or spam email before the user even starts.

Once a new user logs on, then the present invention program connects to the customer's Internet service provider's email server. The program generates SD6 numbers for all of the emails that are in the email server and they are compared to the SD6 hash numbers of the known initial database.

Each new email is assigned a new SD6 hash number so it can be tracked to see if a number of other users have also gotten the same email, which means that those emails are spam emails. The SD6 hash number of an email spam will be compared with entries of the known database to see if there is an existing SD6 hash number already for it and if there is no such hash number that is already in the database, then the new information is provided to the central server that this particular email is given the specific SD6 hash number so it increases the inventory of information.

There are two databases. One keeps track of how many times a user has received a particular email. For each new email the user receives, an SD6 number is generated. This SD6 number is stored in the database (with a counter of 1) that will be sent to the central server. If two or more similar SD6 numbers are generated during this particular email session, then the counter will be incremented for every matching SD6 number.

When the user connects to the central server later on, it is going to send both databases, the one that has the new SD6 number is going to go on the central server and will tell the central server that this SD6 number is a brand new SD6 number. The next database that is going to be sent will contain any existing SD6 number that were found. As this existing SD6 number goes to the central server, the central server is going to automatically know that it has already received this SD6 number and let's say it has already received 20,000 of them, since the central server receives it one more time, its going to increment that count to 20,001. So there are two separate databases that are being transferred to the central server. One database contains all the new numbers that are known to be new SD6 numbers and the other one contains existing SD6 numbers so the central server can increment the counter on it.

So basically the present invention program will compare any new SD6 hashes to it's own internal SD6 definition database. Any SD6 hashes that do not match are added to an outgoing SD6 database that is used to transfer new SD6 hashes to the central server. On the other hand, if a user's email matches a current SD6 definition, then that email is deleted from the customer's ISP email box so the user does not get the spam, i.e., the email spam is “blocked” from reaching the user. These matching SD6 hashes are also stored in another outgoing database that will be sent to the central server for the purpose of updating the SD6 counter for SD6 hashes. The counter keeps track of how many emails have matched a certain SD6 hash.

When the user's computer is connected to the central server, it transmits new SD6 hashes that it has created. The user also receives the latest compiled SD6 spam definitions during this connection so it is always up to date with the latest spam definitions so that it has a full inventory of those that are declared as spam so that it is automatically deleted from its incoming email.

The central server then sends updated spam definition files to all other users within seconds of newly discovered spam. This ensures that all users are protected from new spam even before they check their emails.

In addition to that, spammers try to throw off software who try to catch them by adding in different numbers, sub-numbers, text, html, links, java-script, etc., so that it is not an exact duplicate of somebody else's email so that it cannot be declared as a spam email. This may avoid spam emails to be detected by conventional spam detection programs that requires an identical, i.e. 100%, match of emails that are sent to different email addresses.

However, what the present invention method does is to scan the entire email and generate a SD6 hash code with variable length bits and matches the SD6 hash codes of emails to see how close they are and if there is a comparison of at least a high variable percentage, e.g. 75%, that is the same, then it is known that these are the same email even though the spammer has added modified characters, numbers, etc., to try to throw off the system.

The present invention program for detecting, comparing, blocking, and eliminating email spam can also be installed on and executed by the email servers of the Internet service providers which allows the spam email be stopped even before they reach the users of the email servers.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a block diagram illustrating the implementation of the method of the present invention for detecting, comparing, blocking, and eliminating spam emails, showing the connection between the present invention central server and the mail servers of the Internet service providers (ISPs);

FIG. 2 is a block diagram illustrating the implementation of the method of the present invention for detecting, comparing, blocking, and eliminating spam emails, showing the connection between the present invention central server and the users' computers;

FIGS. 3(a) and 3(b) together form of a flow chart diagram illustrating the logical operation of a preferred embodiment of the present invention method of detecting, comparing, blocking, and eliminating spam emails, showing the essential steps of the computer software program installed and executed on the ISPs' mail servers;

FIGS. 4(a) through 4(c) together form a flow chart diagram illustrating the logical operation of the preferred embodiment of the present invention method of detecting, comparing, blocking, and eliminating spam emails, showing the essential steps of the interactions between the present invention central server and the ISPs' mail servers;

FIGS. 5(a) and 5(b) together form a flow chart diagram illustrating the logical operation of the preferred embodiment of the present invention method of detecting, comparing, blocking, and eliminating spam emails, showing the essential steps of the computer software program installed and executed on the users' computers;

FIGS. 6(a) through 6(c) together form a flow chart diagram illustrating the logical operation of the preferred embodiment of the present invention method of detecting, comparing, blocking, and eliminating spam emails, showing the essential steps of the interactions between the present invention central server and the users' computers; and

FIG. 7 is a flow chart diagram illustrating the logical operation of a preferred embodiment of the Spam Decipher version 6 (SD6) algorithm of the present invention method of detecting, comparing, blocking, and eliminating spam emails.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

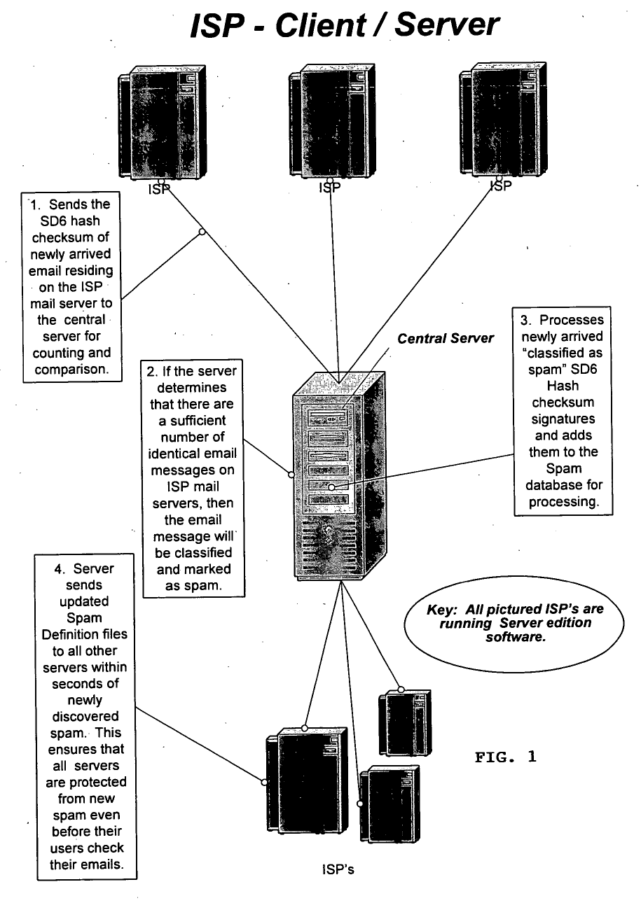

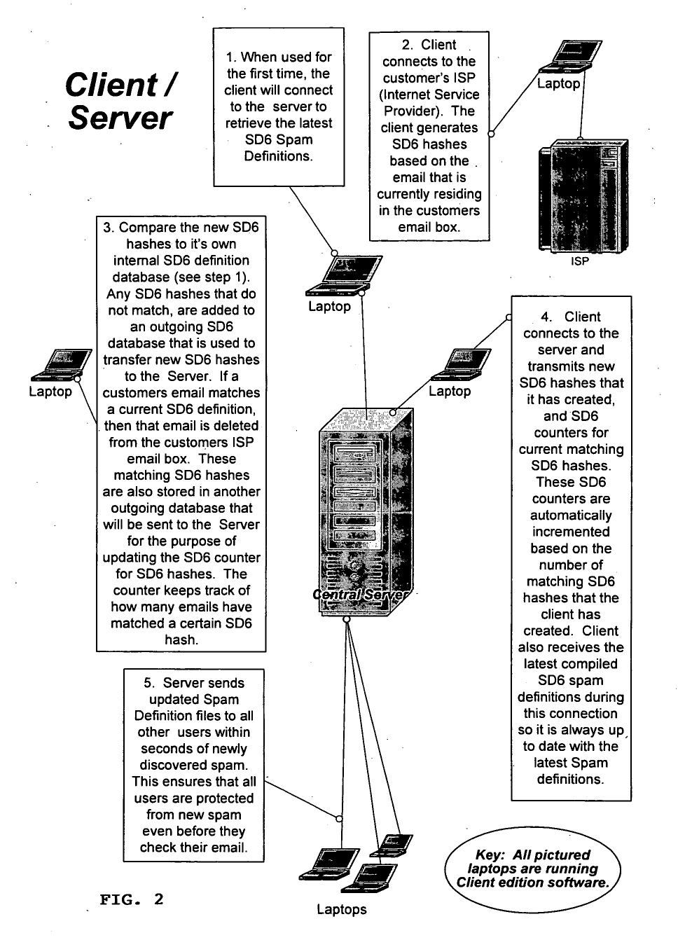

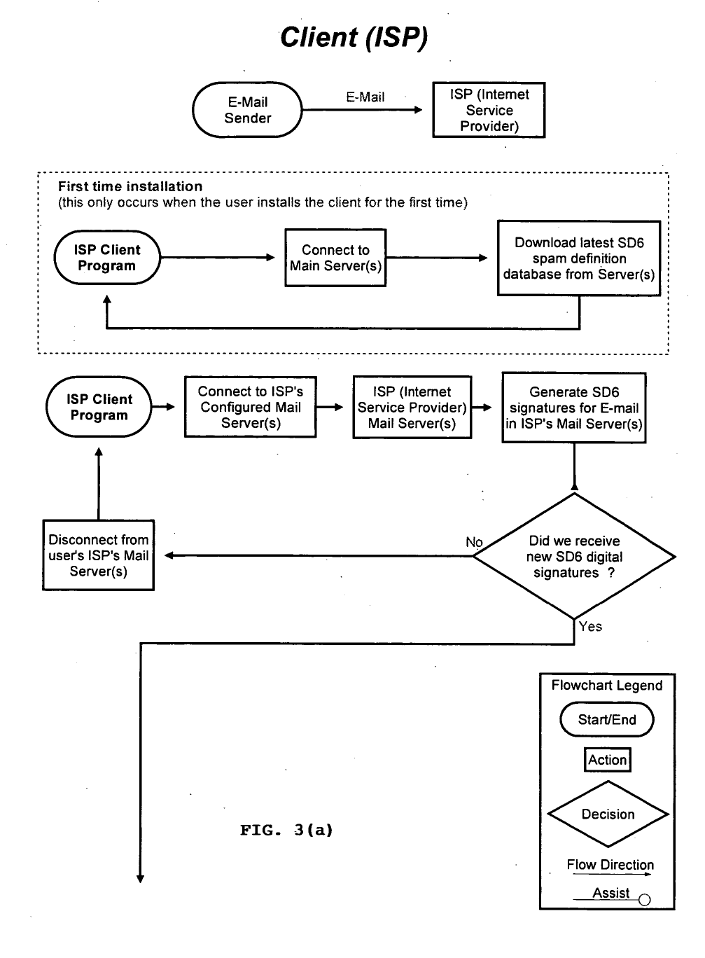

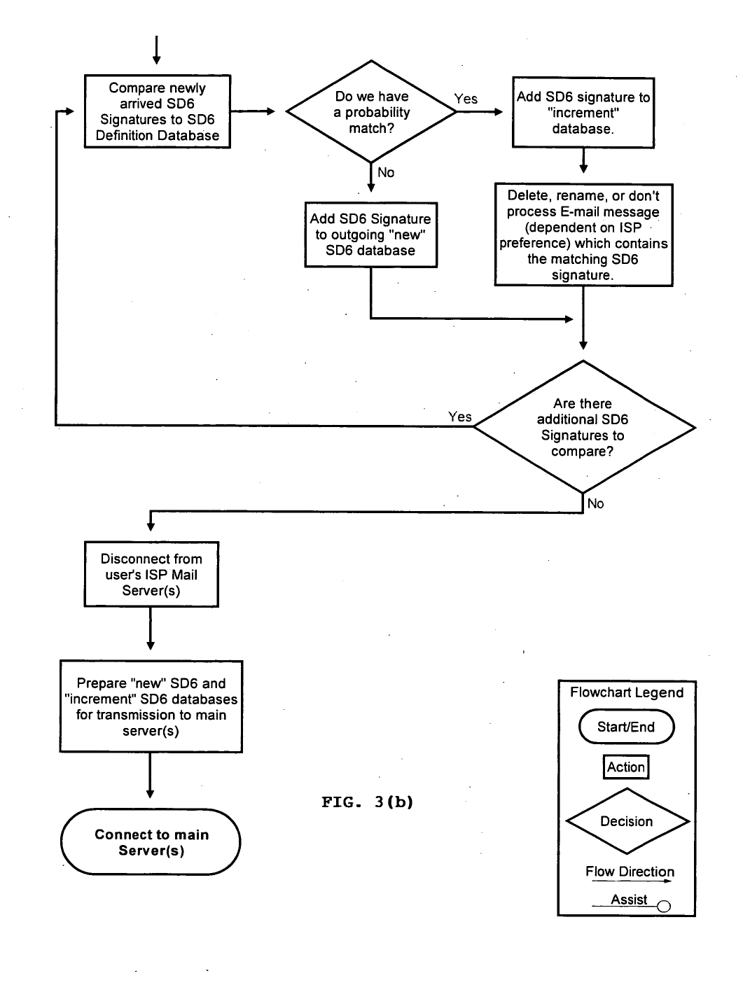

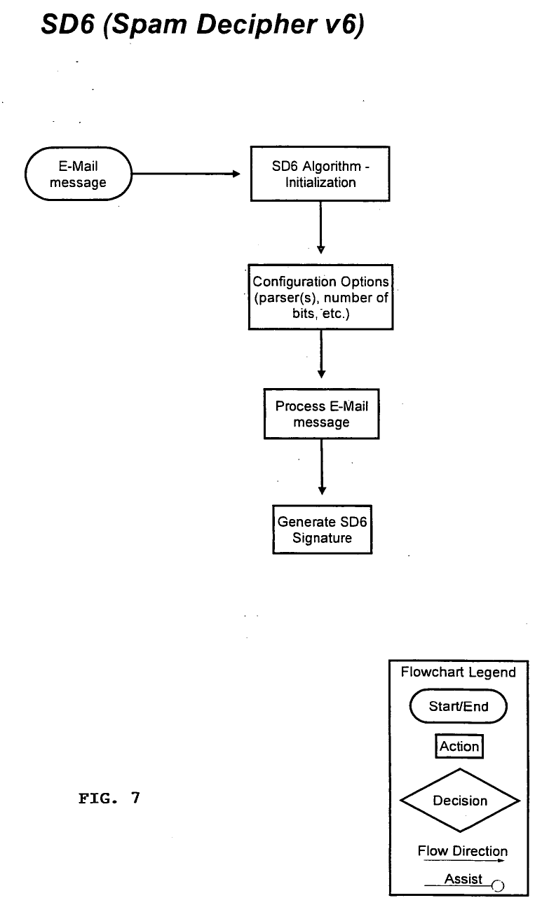

The basic process of the present invention method and program for detecting, comparing, blocking, and eliminating email spam will be first described below in general terms in conjunction with FIGS. 1 and 2, followed by detailed step-by-step description of the present invention spam detecting and blocking computer soft program and algorithm in conjunction with FIGS. 3(a) through 6(b), and detailed description of Spam Decipher version 6 (SD6) hash algorithm in conjunction with FIG. 7.

Referring to FIG. 1, there is shown a block diagram illustrating the implementation of the method of the present invention for detecting, comparing, blocking, and eliminating email spam, showing the connection between a central server 10 of the present invention spam detecting, comparing, blocking, and eliminating service and the mail servers 20 of third party Internet service providers (ISPs).

As shown in FIG. 1, the central server 10 is connected through computer networks such as the Internet to the third party ISPs' mail servers 20.

The present invention email spam detecting, comparing, blocking, and eliminating computer software program include three component parts: a central server program, an ISP program, and a user client program.

The central server program of the present invention is installed and running on the central server 10, whereas the ISP program of the present invention is installed and running on the ISPs' mails servers 20.

The ISP program sends a present invention SD6 hash checksum of each newly arrived email residing on an ISP mail server 20 to the central server 10 for counting and comparison. If the central server program on the central server 10 determines that there are a sufficient number of identical email messages on the ISP mail server 20, then the email message will be classified and marked as spam.

The central server program on the central server 10 then processes newly arrived SD6 hash checksum signatures that are classified as spam and adds them to a spam database established and maintained by the central server program on the central server 10.

In addition, the central server 10 sends updated spam definition files to all other ISP mail servers 20 within seconds of newly discovered spam. This ensures that all ISP mail servers 20 are protected from new spam even before their users check their emails.

Referring to FIG. 2, there is shown a block diagram illustrating the implementation of the method of the present invention for detecting, comparing, blocking, and eliminating email spam.

FIG. 2 shows the connection between the present invention system central server 10, the ISPs' email servers 20, and the users' computers 30, all through computer networks such as the Internet. The user client program of the present invention is installed and running on the users' computers 30.

When used for the first time, a user of the present invention spam detecting, comparing, blocking, and eliminating service will connect to the central server to retrieve the latest SD6 spam definitions.

When the user of the present invention spam detecting, comparing, blocking, and eliminating service connects the user's computer 30 to the user's ISP mail server 20, the user program generates SD6 hashes based on the email that is currently residing in the user's email box. The user program compares the new SD6 hashes to its own internal SD6 definition database. Any SD6 hashes that do not match are added to an outgoing SD6 database that is used to transfer new SD6 hashes to the central server 10. If a user's email matches a current SD6 definition, then that email is deleted form the user's ISP email box. These matching SD6 hashes are also stored in another outgoing database that will be sent to the central server 10 for the purpose of updating the SD6 counter for SD6 hashes. The counter keeps track of how many emails have matched a certain SD6 hash.

When the user's computer 30 connects to the central server 10, it transmits new SD6 hashes that it has created, and SD6 counters for current matching SD6 hashes. These SD6 counters are automatically incremented based on the number of matching SD6 hashes that the user has created. The user also receives the latest compiled DS6 spam definitions during this connection so it is always up to date with the latest Spam definitions.

The central server 10 then sends updated spam definition files to all other users' computers 30 within seconds of newly discovered spam. This ensures that all users of the present invention email spam detecting, comparing, blocking, and eliminating service are protected from new spam even before they even check their email.

Referring to FIGS. 3(a) and 3(b), there is shown a flow chart diagram illustrating the logical operation of a preferred embodiment of the present invention method of detecting, comparing, blocking, and eliminating email spam, demonstrating the essential steps of the ISP program installed and executed on the ISPs' mail servers 20. At the first time installation, the latest SD6 spam definition database is downloaded from the central server 10 to an ISP mail server 20.

When new emails arrive at the ISP mail server 20, the ISP program will generate SD6 hash codes (or “signatures”) for the newly arrived emails, and compare the new SD6 signatures with the SD6 spam definition database loaded on the ISP mail server 20.

If there is a probability match, i.e., code matching at a pre-determined high percentage (e.g., a 75% match but not 100% identical match), then the new SD6 signature is added to an “increment” database and the corresponding email is deemed spam email and deleted or otherwise processed (e.g., blocked/rejected, renamed or placed in a separate file folder).

If the probability match does not occur, i.e., code matching below the pre-determined high percentage, then the new SD6 signature is added to a “new signatures” database and the corresponding email is allowed.

Once all newly arrived emails in the ISP mail server 20 are processed as described above, then the newly updated “increment” database and “new signature” database are ready to be sent to the present invention central server 10 upon the next connection.

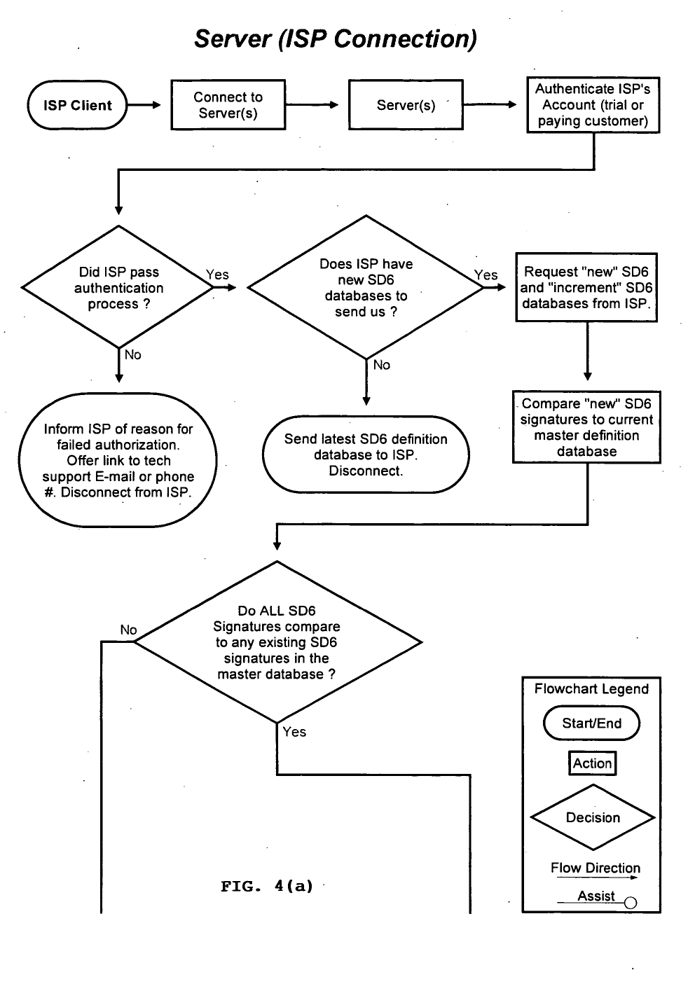

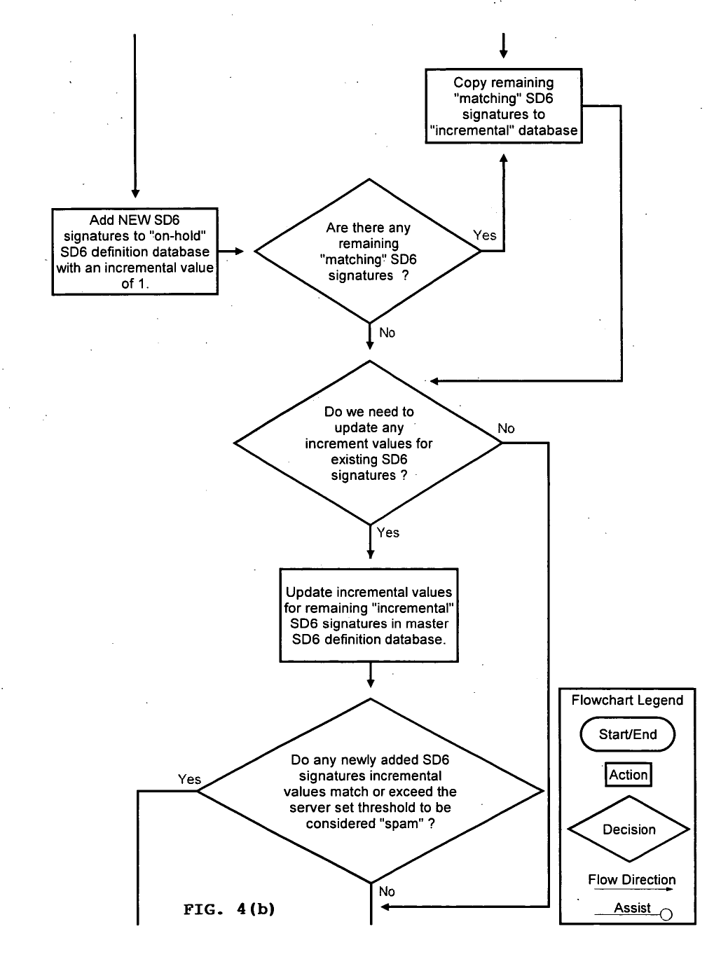

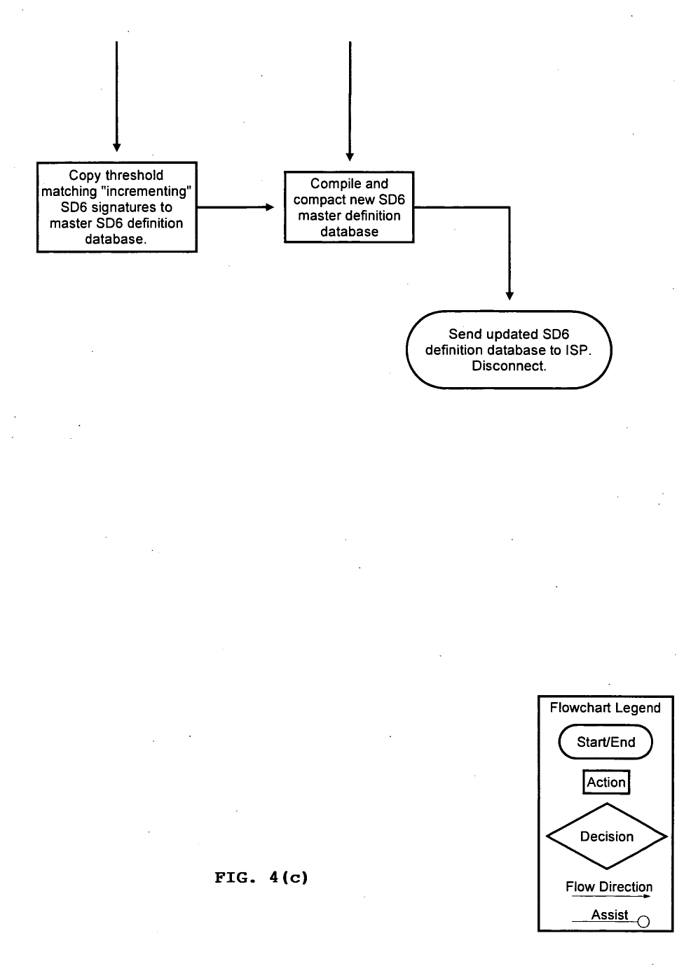

Referring to FIGS. 4(a) through 4(c), there is shown is a flow chart diagram illustrating the logical operation of a preferred embodiment of the present invention method of detecting, comparing, blocking, and eliminating email spam, demonstrating the essential steps of the central server program for interactions between the central server 10 and the ISPs' mail servers 20.

When an ISP's mail server 20 is connected to the present invention central server 10, the log on account of the ISP's mail server 20 is first authenticated.

If the ISP mail server 20 has no new databases (i.e., the new signature database and the increment database) to be sent to the central server 10, then the latest SD6 database on the central server 10 is sent to the ISP mail server 20 to update the database on the ISP mail server 20.

If the ISP mail server 20 has new databases (i.e., the new signature database and increment database) to be sent to the central server 10, then the new SD6 signatures from the ISP mail server 20 are compared with the SD6 definitions in the master database on the central server 10.

All new SD6 signatures from the ISP mail server 20 that do not match any existing SD6 signatures in the master database on the central server 10 are added to a “on-hold” database with an initial counter value of 1.

All new SD6 signatures from the ISP mail server 20 that do match any existing SD6 signatures in the master database on the central server 10 are copied to an “incremental” database, and then the values of the counters of the matching existing SD6 signatures in the master database are incremented by the number of matches.

If the incremental value of any the any newly added SD6 signatures reaches or exceeds a pre-set threshold for being considered spam, then such threshold-reaching SD6 signatures are copied into the master SD6 database.

Once the master SD6 database on the central server 10 is compiled and updated, it is sent to all ISP mail servers 20 so that the spam database on the ISP mail servers 20 are kept current.

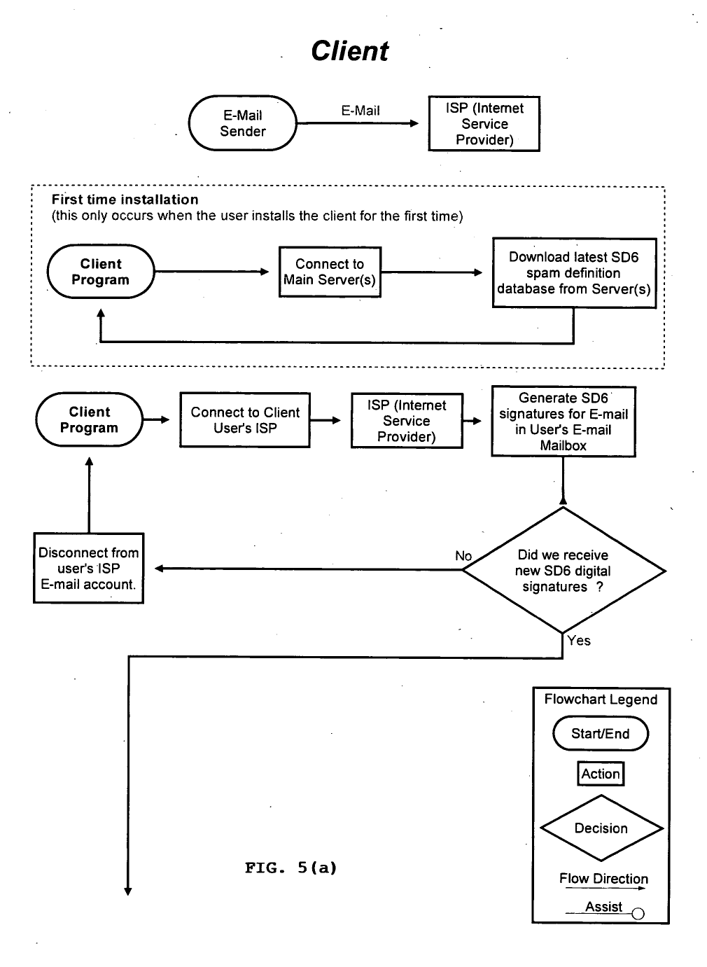

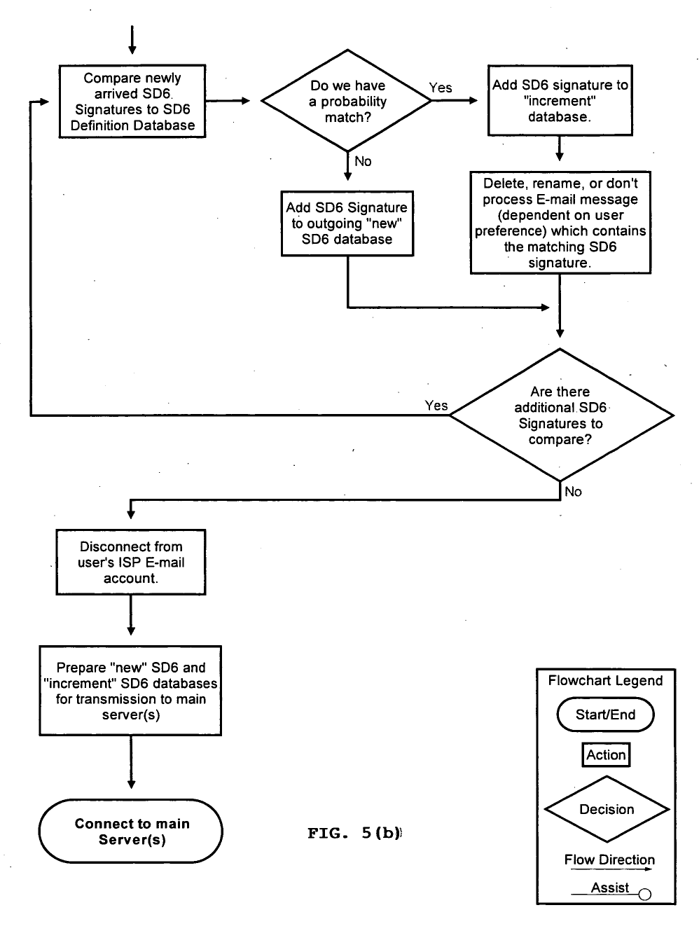

Referring to FIGS. 5(a) and 5(b), there is shown a flow chart diagram illustrating the logical operation of a preferred embodiment of the present invention method of detecting, comparing, blocking, and eliminating email spam, demonstrating the essential steps of the user program installed and executed on the users' computers 30.

Again, at the first time installation, the latest SD6 spam definition database is downloaded from the central server 10 to the user's computer 30.

When the user's computer 30 is connected to the user's ISP server 20 to retrieve the user's emails from the user's email mailbox, the user program will generate SD6 signatures for the emails in the user's mailbox, and compare the new SD6 signatures with the SD6 spam definition database loaded on the user's computer 30.

If there is a probability match, i.e., code matching at a pre-determined high percentage (e.g., a 75% match but not a 100% identical match), then the new SD6 signature is added to an “increment” database and the corresponding email is deemed spam email and deleted or otherwise processed (e.g., blocked/rejected, renamed or placed in a separate file folder).

If the probability match does not occur, i.e., code matching below the pre-determined high percentage, then the new SD6 signature is added to a “new signatures” database and the corresponding email is allowed.

Once all emails in the user's email mailbox are processed as described above, then the newly updated “increment” database and “new signature” database are ready to be sent to the present invention central server 10 upon the next connection.

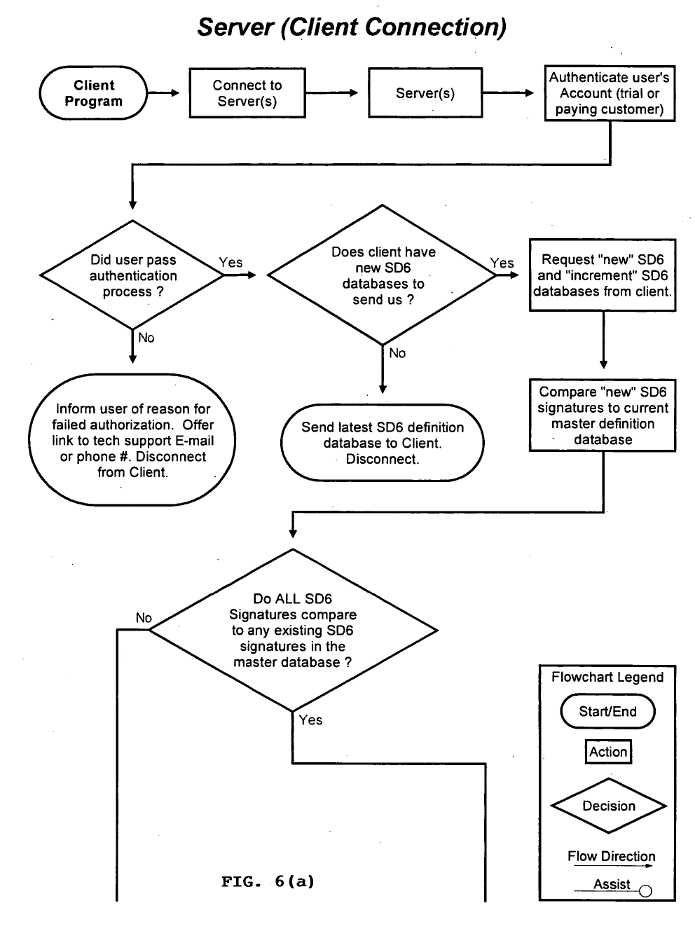

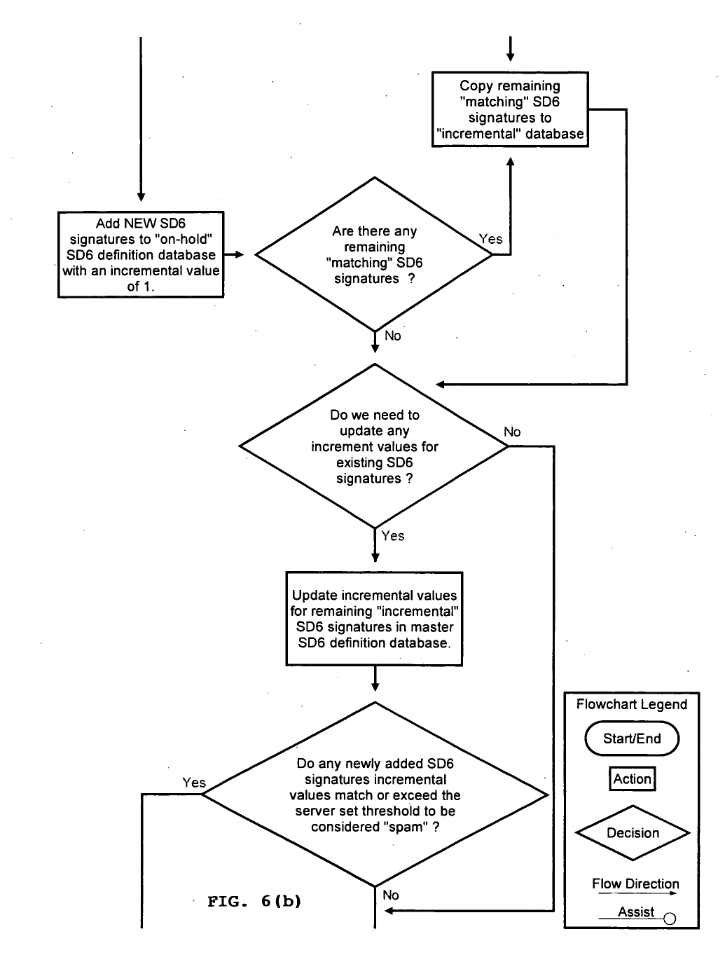

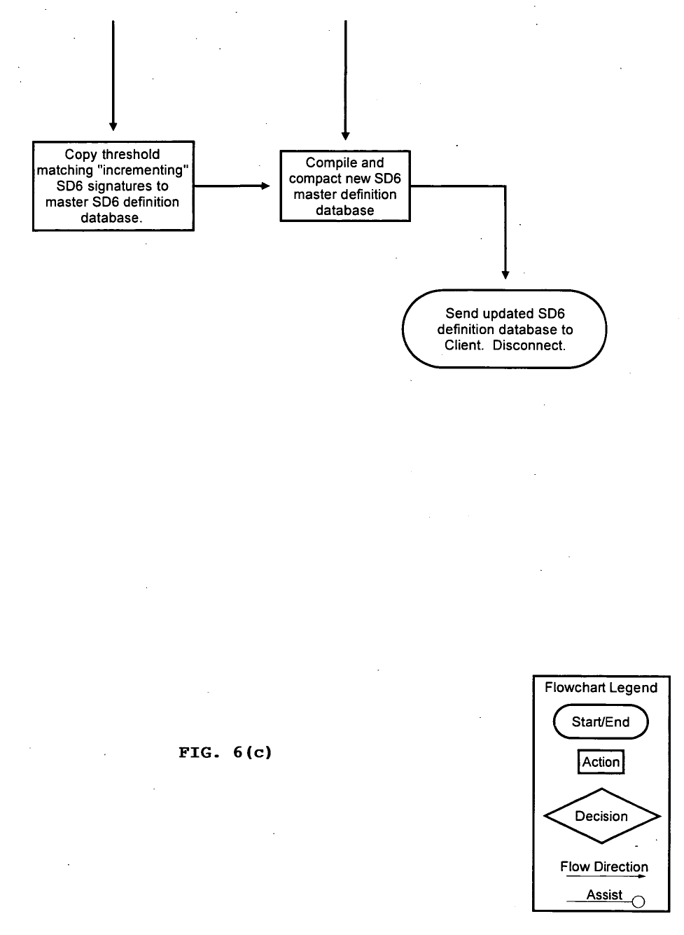

Referring to FIGS. 6(a) through 6(c), there is shown a flow chart diagram illustrating the logical operation of a preferred embodiment of the present invention method of detecting, comparing, blocking, and eliminating email spam, demonstrating the essential steps of the central server program for interactions between the central server 10 and the user's computer 30.

When a user's computer 30 is connected to the present invention central server 10, the log on account of the user is first authenticated.

If the user's computer 30 has no new databases (i.e., the new signature database and the increment database) to be sent to the central server 10, then the latest SD6 database on the central server 10 is sent to the user's computer 30 to update the database on the user's computer 30.

If the user's computer 30 has new databases (i.e., the new signature database and increment database) to be sent to the central server 10, then the new SD6 signatures from the user's computer 30 are compared with the SD6 definitions in the master database on the central server 10.

All new SD6 signatures from the user's computer 30 that do not match any existing SD6 signatures in the master database on the central server 10 are added to a “on-hold” database with an initial counter value of 1.

All new SD6 signatures from the user's computer 30 that do match any existing SD6 signatures in the master database on the central server 10 are copied to an “incremental” database, and then the values of the counters of the matching existing SD6 signatures in the master database are incremented by the number of matches.

If the incremental value of any the any newly added SD6 signatures reaches or exceeds a pre-set threshold for being considered spam, then such threshold-reaching SD6 signatures are copied into the master SD6 database.

Once the master SD6 database on the central server 10 is compiled and updated, it is sent to all users' computers 30 so that the spam database on the users' computers 20 are also updated.

Referring to FIG. 7, the SD6 signatures or hashes of emails are generated by an SD6 algorithm. The process includes initialization, configuration of options, and hashing which generates the SD6 signature of the processed email. The result is an SD6 hash code that is preferably (but not limited to) a 416 bit hash code, much longer than the conventional Message-Digest version 5 (MD5) code.

The present invention SD6 is a one way “sensitive” hash that turns email messages into a fixed string result of alphanumerical characters. The “one way” phrase means that it is impossible to derive the original text from the returned SD6 hash string. Whereas conventional hash algorithms will not produce similar strings from two slightly different inputs, SD6 algorithm will produce a similar string even if two email messages contain most of the same content, but also contain different “spammer” altered content in the spammers' effort to try and bypass spam filters that are currently developed.

An example of a conventional hash function that returns two totally different strings of two slightly different emails would be the MD5 algorithm. For example, MD5 hash code for the word “dog” and the word “dogs” are totally different. By looking at these MD5 results, one would never know that original texts of “dog” and “dogs” were very similar. Therefore, MD5 can not be used to determine similar span email messages because the slightest character change will alter the MD5 hash text string result, which is useless for comparison purposes.

The SD6 hash algorithm takes the whole email message and passes it through the SD6 function. The SD6 function reads every character of an email including headers, embedded html, and java-script, etc. It does not strip or skip over alphanumerical characters, digits, dashes, apostrophes, dollar signs, dates, subjects, server names, mailer versions, protocols, or attachments, etc.

The “sensitive” hash result is of variable length. The text based hash string output of SD6 can range from any number of bits. This makes SD6 algorithm more “sensitive” in the future as spammers evolve their spam email messages when they try to defeat SD6.

The resulting string from SD6 does not automatically shorten itself if it is fed a smaller email message. Rather, SD6 will return the same length text result regardless of the length of the original email message text. For example, the SD6 hash code of an email message that is 4 lines long (or 160 characters) is the same as the SD6 hash code of another email message text that is 20 lines long (or 8000 characters). SD6 may be preset to be of any length (e.g., 160-bit or 416-bit). The present invention is not limited to any pre-determined string lengths. The resulting string length or bit length can easily be change.

It is computationally infeasible to produce two similar SD6 results when two different email messages that contain none of the same content are processed. The SD6 result will only by similar when the content in email messages is similar. The email message does not need to be identical. For example, if an email message can contains 75% of the same content as another email message, the SD6 result will show this similarity in the messages. But if two email messages contain only 10% of the same content, we will know this as well because the SD6 results will look different from one another. The SD6 result will let us know that those two messages contain only 10% of the same content based on the bits in the SD6 result.

The SD6 algorithm is designed to be very fast on 32-bit machines. It does not require any use of hash tables. The algorithm was coded to be very compact.

The present invention method has many important advantages. It provides a spam detecting, comparing, blocking, and eliminating method with a new spam decipher hash code algorithm that does not “strip” emails when hashing and generates a new spam decipher signature that does not require a 100% match in spam signatures in order to detect spam emails.

Defined broadly, the present invention is a method of detecting, comparing, blocking, and eliminating spam emails sent through email servers of Internet service providers (ISPs), comprising the steps of: (a) generating a spam decipher signature for each email in an ISP's mail server; (b) comparing newly generated spam decipher signatures to a server database containing spam decipher signatures of known spam emails to detect spam emails when there is a probability match at a pre-determined high percentage; (c) preventing the spam emails from going through the ISP's mail server as non-spam emails; (d) adding non-matching spam decipher signatures to a new signature database; (e) comparing spam decipher signatures in the new signature database with existing spam decipher signatures in a master spam decipher signature database; (f) incrementing a counter value of a matching spam decipher signature by the number of matches; and (g) adding all new spam decipher signatures that have counter values reaching or exceeding a pre-set threshold and therefore are considered spam to said master spam decipher signature database.

Defined more broadly, the present invention is a method of detecting, comparing, blocking, and eliminating spam emails sent through email servers of Internet service providers (ISPs), comprising the steps of: (a) generating a spam decipher signature for each email in an ISP's mail server; (b) comparing newly generated spam decipher signatures to a server database containing spam decipher signatures of known spam emails to detect spam emails when there is a probability match at a pre-determined high percentage; and (c) preventing the spam emails from going through the ISP's mail server as non-spam emails.

Alternatively defined broadly, the present invention is a method of detecting, comparing, blocking, and eliminating spam emails sent to email users' email-boxes, comprising the steps of: (a) generating a spam decipher signature for each email in an email user's email-box; (b) comparing the newly generated spam decipher signatures to a user database containing spam decipher signatures of known spam emails to detect spam emails when there is a probability match at a predetermined high percentage; (c) preventing the spam emails from going to the email user as non-spam emails; (d) adding non-matching spam decipher signatures to a new signature database; (e) comparing spam decipher signatures in the new signature database with existing spam decipher signatures in a master spam decipher signature database; (f) incrementing a counter value of a matching spam decipher signature by the number of matches; and (g) adding all new spam decipher signatures that have counter values reaching or exceeding a pre-set threshold and therefore are considered spam to said master spam decipher signature database.

Alternatively defined more broadly, the present invention is a method of detecting, comparing, blocking, and eliminating spam emails sent to email users' email-boxes, comprising the steps of: (a) generating a spam decipher signature for each email in an email user's email-box; (b) comparing newly generated spam decipher signatures to a user database containing spam decipher signatures of known spam emails to detect spam emails when there is a probability match at a pre-determined high percentage; and (c) preventing the spam emails from going to the email user as non-spam emails.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the method shown is intended only for illustration and disclosure of an operative embodiment and not to show all of the various forms or modifications in which this invention might be embodied.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A method of detecting, comparing, blocking, and eliminating spam emails sent through email servers of Internet service providers (ISPs), comprising the steps of:
a. generating a spam decipher signature for each email in an ISP's mail server;
b. comparing newly generated spam decipher signatures to a server database containing spam decipher signatures of known spam emails to detect spam emails when there is a probability match at a pre-determined high percentage; and
c. preventing said spam emails from going through said ISP's mail server as non-spam emails.

2. The method in accordance with claim 1, further comprising the steps of adding matching spam decipher signatures to an incremental database and adding non-matching spam decipher signatures to a new signature database.

3. The method in accordance with claim 2, further comprising the step of updating a master spam decipher signatures database with newly detected spam emails.

4. The method in accordance with claim 3, wherein said step of updating said master spam decipher signature database further comprises the steps of:
a. comparing spam decipher signatures in said new signature database with existing spam decipher signatures in said master spam decipher database;
b. incrementing a counter value of a matching spam decipher signature by the number of matches; and
c. adding all new spam decipher signatures that have counter values reaching or exceeding a pre-set threshold and therefore are considered spam to said master spam decipher signature database.

5. The method in accordance with claim 1, further comprising the step of loading said master spam decipher signature database to said ISP email server to establish said server database.

6. The method in accordance with claim 1, further comprising the step of updating said server database with said master spam decipher signature database.

7. A method of detecting, comparing, blocking, and eliminating spam emails sent through email servers of Internet service providers (ISPs), comprising the steps of:
a. generating a spam decipher signature for each email in an ISP's mail server;
b. comparing newly generated spam decipher signatures to a server database containing spam decipher signatures of known spam emails to detect spam emails when there is a probability match at a pre-determined high percentage;
c. preventing said spam emails from going through said ISP's mail server as non-spam emails;
d. adding non-matching spam decipher signatures to a new signature database;
e. comparing spam decipher signatures in said new signature database with existing spam decipher signatures in a master spam decipher signature database;
f. incrementing a counter value of a matching spam decipher signature by the number of matches; and
g. adding all new spam decipher signatures that have counter values reaching or exceeding a pre-set threshold and therefore are considered spam to said master spam decipher signature database.

8. The method in accordance with claim 7, further comprising the step of adding matching spam decipher signatures to an incremental database.

9. The method in accordance with claim 7, further comprising the step of loading said master spam decipher signature database to said ISP email server to establish said server database.

10. The method in accordance with claim 1, further comprising the step of updating said server database with said master spam decipher signature database.

11. A method of detecting, comparing, blocking, and eliminating spam emails sent to email users' email-boxes, comprising the steps of:
a. generating a spam decipher signature for each email in an email user's email-box;
b. comparing newly generated spam decipher signatures to a user database containing spam decipher signatures of known spam emails to detect spam emails when there is a probability match at a pre-determined high percentage; and
c. preventing said spam emails from going to said email user as non-spam emails.

12. The method in accordance with claim 11, further comprising the steps of adding matching spam decipher signatures to an incremental database and adding non-matching spam decipher signatures to a new signature database.

13. The method in accordance with claim 12, further comprising the step of updating a master spam decipher signature database with newly detected spam emails.

14. The method in accordance with claim 13, wherein said step of updating said master spam decipher signature database further comprises the steps of:
a. comparing spam decipher signatures in said new signature database with existing spam decipher signatures in said master spam decipher database;
b. incrementing a counter value of a matching spam decipher signature by the number of matches; and
c. adding all new spam decipher signatures that have counter values reaching or exceeding a pre-set threshold and therefore are considered spam to said master spam decipher signature database.

15. The method in accordance with claim 11, further comprising the step of loading said master spam decipher signature database to said email user's computer to establish said user database.

16. The method in accordance with claim 11, further comprising the step of updating said user database with said master spam decipher signature database.

17. A method of detecting, comparing, blocking, and eliminating spam emails sent to email users' email-boxes, comprising the steps of:
a. generating a spam decipher signature for each email in an email user's email-box;
b. comparing the newly generated spam decipher signatures to a user database containing spam decipher signatures of known spam emails to detect spam emails when there is a probability match at a pre-determined high percentage;
c. preventing said spam emails from going to said email user as non-spam emails;
d. adding non-matching spam decipher signatures to a new signature database;
e. comparing spam decipher signatures in said new signature database with existing spam decipher signatures in a master spam decipher signature database;
f. incrementing a counter value of a matching spam decipher signature by the number of matches; and
g. adding all new spam decipher signatures that have counter values reaching or exceeding a pre-set threshold and therefore are considered spam to said master spam decipher signature database.

18. The method in accordance with claim 17, further comprising the step of adding matching spam decipher signatures to an incremental database.

19. The method in accordance with claim 17, further comprising the step of loading said master spam decipher signature database to said email user's computer to establish said user database.

20. The method in accordance with claim 1, further comprising the step of updating said user database with said master spam decipher signature database.
